(19) United States
(12) Patent Application Publication
(10) Pub. No.: US 2003/0016232 A1
(43) Pub. Date: Jan. 23, 2003

(54) Computer graphics system and method of rendering polygons

(76) Inventor: Cornelius Wilhelmus Antonius Marie Van Overveld, Eindhoven (NL)

Correspondence Address: U.S. Philips Corporation, 580 White Plains Road, Tarrytown, NY, 10591, US

(21) Appl. No.: 10/196,320

(22) Filed: Jul. 16, 2002

(30) Foreign Application Priority Data
Jul. 20, 2001 (EP) 01202793.4

(51) Int. Cl. G09G 5/00; G06T 15/40

(52) U.S. Cl. 345/611; 345/422

(57) ABSTRACT

A computer graphics system (300) arranged to render polygons comprises: a frame memory (310) to store values of pixels; a scan conversion unit (304) for determining which of the pixels are inside polygons (100) and to detect Jags on the edges of the polygons; and a delineating unit (306) for delineating the polygons, being arranged to eliminate Jags (108-120) on the edges (102) of polygons (100) by mixing values of at least two of the pixels to achieve an appropriate value of a particular pixel to be displayed.

The invention relates to a computer graphics system arranged to render polygons, comprising:

a frame memory to store values of pixels;

a scan conversion unit for determining which of the pixels are inside a particular polygon; and

a delineating unit for delineating the particular polygon, being arranged to eliminate Jags on an edge of the particular polygon by mixing values of at least two of the pixels to achieve an appropriate value of a particular pixel to be displayed.

The invention further relates to a method of rendering polygons comprising the steps of:

storing values of pixels in a frame memory;

scan conversion to determine which of the pixels are inside a particular polygon; and

delineating the particular polygon to eliminate Jaggies on an edge of the particular polygon by mixing values of at least two of the pixels to achieve an appropriate value of a particular pixel to be displayed.

A system and method of the kind described in the opening paragraph are known from U.S. Pat. No. 6,052,131.

Rendering 3-D polygons requires discrete sampling of continuous geometric objects, i.e. the polygons to be rendered. Sampling introduces aliasing, which most often reveals itself in the form of Jaggies. In particular in moving sequences, these Jags are very annoying, and anti-aliasing therefore is an essential step in the rendering pipeline. A rigorous approach to anti-aliasing comes down to pre-filtering with a low-pass filter. However, in order to avoid all aliasing, this filter should have a very large footprint, which is not only extremely costly in CPU performance, but also gives rise to an unnecessarily blurred image.

In U.S. Pat. No. 6,052,131 the processing effort is reduced, by restricting the anti-aliasing operations to polygon edges only. In the system of the prior art a first line segment is formed along an edge of a polygon which has been delineated on a frame memory. Then a plurality of second line segments along the length of the first line segment are formed. The second line segments comprise a plurality of pixels and are generally perpendicular to the direction of the first line segment. The values of the second line-segment-pixels may be found using the values of pixels lying on the first line segment. Alternatively, the values of the second-line-segment pixels may be found by interpolation using the values of adjacent pixels lying on the first line segment. In other words, values of pixels are mixed to achieve appropriate pixel values to be displayed. Still, in many cases even this system performs too much work. In most graphical applications a number of polygons are to be rendered. Very often these polygons overlap. In that case it is wasted effort to perform interpolations, i.e. mixing operations, in order to calculate pixel values that are later to be overwritten in the vicinity of all polygons edges.

It is a first object of the invention to provide a computer graphics system of the kind described in the opening paragraph that is designed to reduce Jags with a relatively small number of operations.

It is a second object of the invention to provide a method of the kind described in the opening paragraph which reduces Jags with a relatively small number of operations.

The first object of the invention is achieved in that the scan conversion unit is designed to determine information of the Jags to control the delineating unit. The key aspect of the computer graphics system according to the invention is that Jaggies are removed, by filtering only the environment of the Jaggies. In the system according to the prior art the locations of the Jaggies are not detected, but it is assumed that Jaggies are present somewhere on the edge of the polygon. Filtering is applied on the complete edge of the polygon. It is preferred that the filter in the computer graphics system according to the invention, i.e. part of the delineating unit, is adjusted to the local environment of the Jaggy. In other words, the filter depends on the edge in which the Jaggy occurs. Hence the delineating unit receives: information of the location of Jaggies and information of the orientation of the edge at the position of the Jaggies. Both pieces of information are obtained during scan conversion. Indeed, consider a polygon edge with an orientation, relative to the pixel grid, smaller than 45 degrees. This means that for every next y-value, the scan segment spans an x-interval with initial x-values that differ at least one between two scanlines. So every begin point of a new scanline gives rise to one Jaggy. This is called a horizontal Jaggy. Also for edges with an orientation, relative to the pixel grid, larger than 45 degrees, Jaggies occur at the begin points of segments, but this time only at those scan segments where the initial x-value differs from the initial x-value of the previous scan segment. This is called a vertical Jaggy. So the scan conversion unit, which generates all scan segments, can very easily raise a flag at the occurrence of a Jaggy. At the time of reporting a Jaggy, the scan conversion unit has the information of the polygon at hand, so also the orientations of the relevant edges can be reported easily.

In an embodiment of the computer graphics system according to the invention, the delineating unit is designed to calculate the appropriate value of the particular pixel on the basis of a distance between the particular pixel and a particular Jaggy. The value of the pixel can relate to e.g. luminance or chrominance. Assume that a particular Jaggy is horizontal, and the edge has such a positive orientation that the next Jaggy occurs at N pixels away from the particular Jaggy. Then N/2 pixel-pairs to the right and N/2 pixel-pairs to the left of the particular Jaggy will be processed. These pixel-pairs are horizontally adjacent. For a vertical Jaggy pixel-pairs that have to be processed, are vertically adjacent. Filtering amounts to mixing the values of the two pixels of one pair. Let c₁ and c₂ be the original pixel values of the pair, and c′₁ and c′₂ the new pixel values, then mixing amounts to

c′₁=c₁

c′₂=(1−α)c₁+αc₂

for the pixels on the right from the particular Jaggy, and

c′₁=αc₁+(1−α)c₂

c′₂=c₂

for the pixels on the left from the particular Jaggy. Here α=½ at the position of the Jaggy and α decreases gradually to 0 further away from the Jaggy. The rate of decrease of α follows from the orientation of the edge on which the Jaggy is located.

An embodiment of the computer graphics system according to the invention further comprises a memory device being arranged to store the information of a particular Jaggy, provided by the scan conversion unit. It is preferred that the memory device is a Z-buffer. With a Z-buffer is meant a memory being organized on a pixel base. In literature, e.g. in U.S. Pat. No. 6,052,131, it is described that a Z-buffer is quite often used to store depth information. Storage of other pixel related data is also possible. The advantage using a memory, e.g. the Z-buffer to store information of the Jags, is that in the case of occluding polygons, the underlying information of the Jaggy will become redundant and can be overwritten. Typically, polygons do overlap in images. When all polygons of an image have been scan converted, only the Jaggies of the polygons or portions of the polygons lying in front remain. The anti-aliasing can then be performed for these remaining Jaggies. Information of the Jags may comprise a location of the particular Jaggy and/or an orientation of the edge.

In an embodiment of the computer graphics system according to the invention comprising a Z-buffer being arranged to store the information of a particular Jaggy, this data might be stored in one bit-layer of the Z-buffer. This bit-layer is initially filled with all zeroes. If the scan converter reports a Jaggy, than the Z-buffer will receive a small bit pattern in that bit layer in the vicinity of that Jaggy. For a horizontal Jaggy in a substantially horizontal edge, this is a pattern of 3 rows of each 2 pixels. With a substantially horizontal edge is meant an orientation of the edge relative to the pixel grid, smaller than 45 degrees. For a vertical Jaggy in a substantially vertical edge, this is the pattern of 2 rows of each 3 pixels. The bit pattern has at least two 1-bits, i.e. the lower left and the upper right positions in order to identify the location of the Jaggy. The remaining 4 bits can encode up to 16 different orientations. Such a bit pattern, which encodes both the location and the orientation of the associated edge in a Jaggy will be called a Jaggy witness.

In an embodiment of the computer graphics system according to the invention comprising a Z-buffer being arranged to store the information of a particular Jaggy, this data comprises a relation between the particular Jaggy and a second Jaggy. An implementation of such relation might be the memory pointer to the second Jaggy. The advantage of storing this data is that retrieving the list of detected Jags from the memory device can be quite fast.

The second object of the invention is achieved in that in the step of scan conversion information of the Jags is determine to control the delineating.

Modifications of the computer graphics system and variations thereof may correspond to modifications and variations thereof of the method described.

These and other aspects of the computer graphics system and of the method according to the invention will become apparent from and will be elucidated with respect to the implementations and embodiments described hereinafter and with reference to the accompanying drawings, wherein:

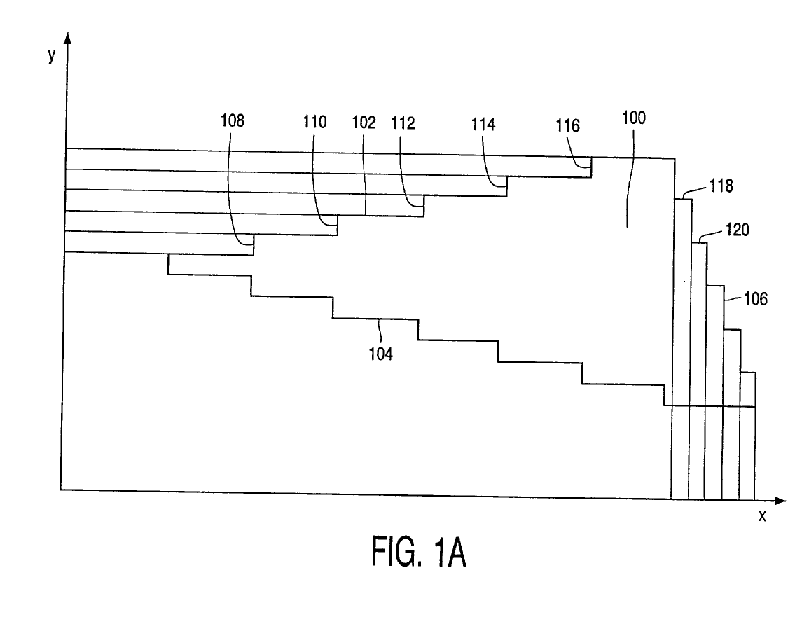

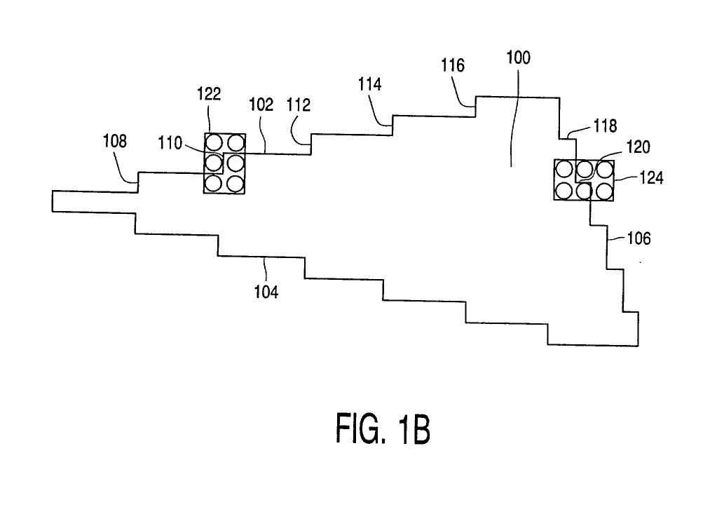

FIG. 1A schematically shows a polygon with Jags;

FIG. 1B schematically shows a polygon with Jags and two Jaggy witnesses;

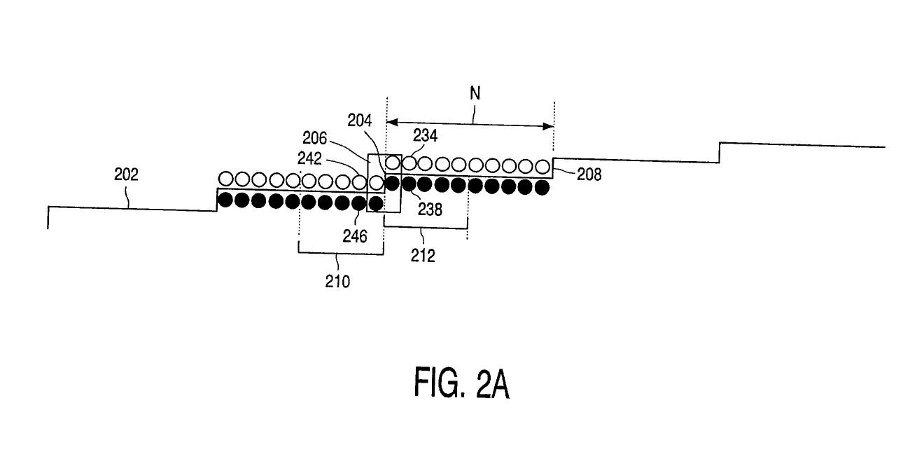

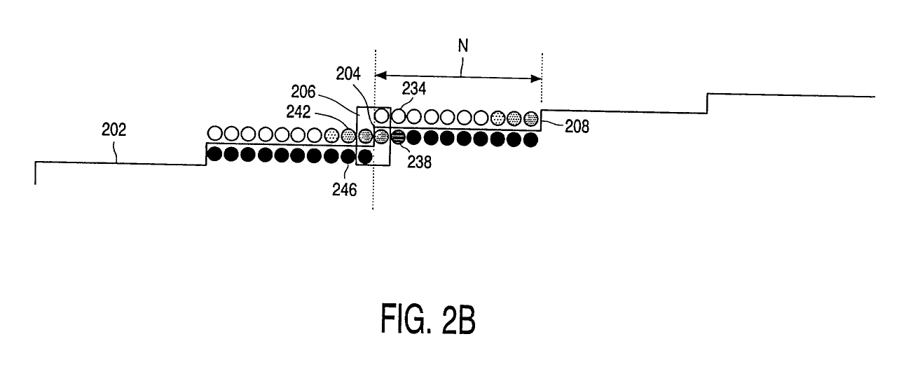

FIG. 2A schematically shows a configuration of a horizontal Jaggy, indicated by a Jaggy witness, together with the involved pixels;

FIG. 2B schematically shows the pixels after mixing has taken place;

FIG. 2C schematically shows the process of mixing; and

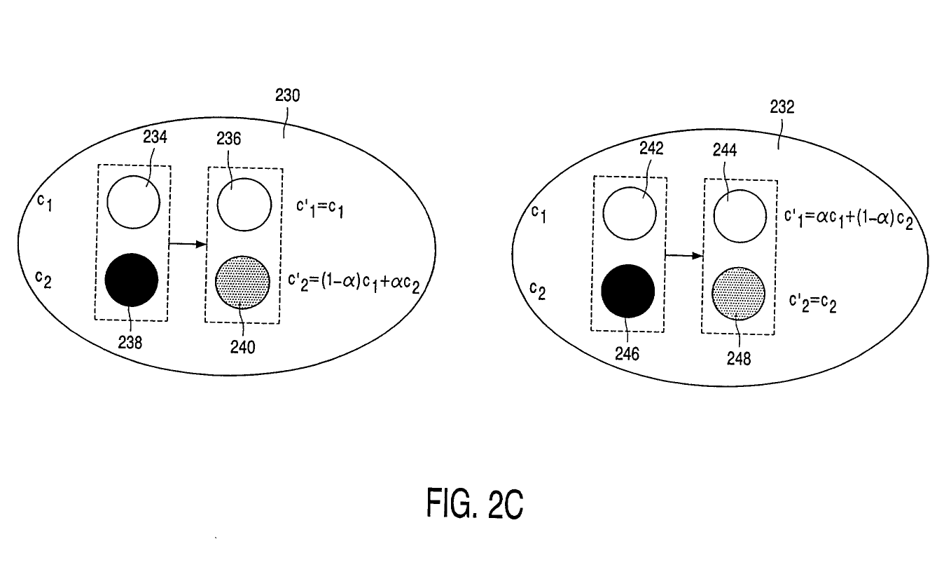

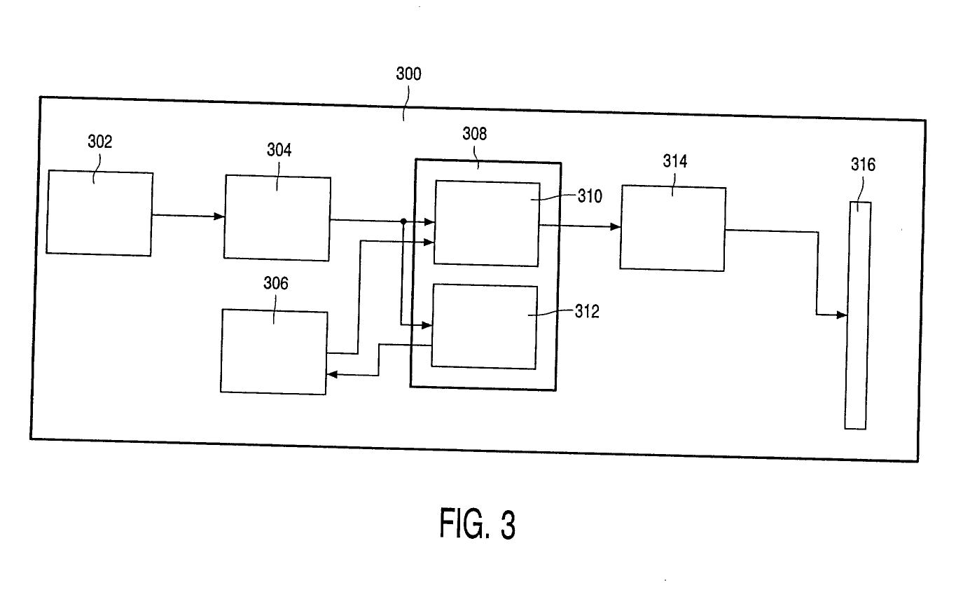

FIG. 3 schematically shows an embodiment of the computer graphics system.

Corresponding reference numerals have the same meaning in all of the Figures.

Rendering 3-D polygons requires discrete sampling of continuous geometric objects, i.e. the polygons to be rendered. Sampling introduces aliasing, which most often reveals itself in the form of Jags. FIG. 1A schematically shows a polygon 100 with Jags 108-120. The polygon 100, i.e. a triangle, has three edges 102, 104 and 106. The Jags 108-116 on edge 102 are called horizontal Jags: one Jaggy for every y-value. The Jags 118 and 120 on edge 106 are called vertical Jags: one Jaggy for every x-value.

FIG. 1B schematically shows two Jaggy witnesses 122 and 124 of the polygon 100. A Jaggy witness is a bit pattern which encodes both the location of a Jaggy and the orientation of the associated edge in the Jaggy. Jaggies can be characterized by 6 pixels:

A horizontal Jaggy, e.g. 110 can be characterized with 3 rows of 2 pixels: Jaggy witness 122.

A vertical Jaggy, e.g. 120 can be characterized with 2 rows of 3 pixels Jaggy witness 124.

A Jaggy witnesses can be stored with a small bit pattern in one bit-layer in the vicinity of a Jaggy. The bit pattern has at least two 1-bits, i.e. the lower left and the upper right positions in order to identify the location of the Jaggy. The remaining 4 bits can encode up to 16 different orientations. Other ways of storage of information of Jaggies are also possible.

FIG. 2A schematically shows a configuration of a horizontal Jaggy 204, indicated by a Jaggy witness 206, together with the involved pixels. The distance N between two Jags 204 and 208 is inversely proportional to the orientation of the edge 202 relative to the pixel grid. N/2 pixel-pairs to the right 212 and N/2 pixel-pairs to the left 210 of the particular Jaggy 204 will be processed. These pixel-pairs are horizontally adjacent. Filtering amounts to mixing the values of the two pixels of one pair. FIG. 2B schematically shows the pixels after mixing has taken place. E.g. the pixels 238 and 242 have a value which is based on mixing.

FIG. 2C schematically shows the process of mixing:

Let c₁ 234 and c₂ 238 be the original pixel values of a pair on the right from the particular Jaggy 204, and c′₁ 236 and c′₂ 240 the new pixel values, then mixing amounts to

c′₁=c₁

c′₂=(1−α)c₁+αc₂

Let c₁ 242 and c₂ 246 be the original pixel values of a pair on the left from the particular Jaggy 204, and c′₁ 244 and c′₂ 248 the new pixel values, then mixing amounts to

c′₁=αc₁+(1−α)c₂

c′₂=c₂

Here α=½ at the position of the Jaggy 204 and α decreases gradually to 0 further away from the Jaggy. The rate of decrease of α follows from the orientation of the edge 202 on which the Jaggy 204 is located.

FIG. 3 schematically shows an embodiment of the computer graphics system 300 comprising:

a processor 302 designed to generate polygon descriptions. A polygon can be described by the coordinates of its vertices;

a memory unit 308 with a frame memory 310 to store values of pixels and a memory device 312, e.g. a Z-buffer to store information of Jags;

a scan conversion unit 304 for determining which of the pixels are inside polygons and to detect Jags. The input of the scan conversion unit 304 is provided by the processor 302 and comprises the coordinates of the vertices of the polygons. The output of the scan conversion unit 304 comprises a list of pixels which are inside the polygons. Information of pixels indicating that they are comprised by a particular polygon is stored in the frame memory 310. Information of Jags is stored in the memory device 312;

a delineating unit 306 for delineating the polygons, being arranged to eliminate Jags on edges of the polygons by mixing values of at least two of the pixels to achieve an appropriate value of a particular pixel to be displayed. The mixing is described in connection with FIG. 2C. The data to be processed is retrieved from the memory unit 308 and the pixel data is stored in the frame memory 310; and

a video controller 314 which reads out written pixel data, being delineated pixel data, from the frame memory 310 and transforms the pixel data into video signals which are then supplied to a monitor 316. This causes an image corresponding to the pixel data from the frame memory to be displayed on a monitor.

The behavior of the computer graphics system 300 is as follows. The processor 302 provides the coordinates of the vertices of a number of polygons which have to be displayed together, to the scan conversion unit 304. These vertices of the consecutive polygons are provided on a polygon base, i.e. first all coordinates of the first polygon, then of the second, then of the third, etcetera. The scan conversion unit 304 determines for each polygon which pixels are comprised by the polygon under consideration and detects the Jags of the polygon. The output is stored in the memory unit 308. When all polygons which have to be displayed together in one image have been processed, the delineating unit 306 starts to remove the Jags which have not been overlapped by other polygons. The final step is that the video controller 314 reads out written pixel data, being delineated pixel data, from the frame memory 310 and transforms the pixel data into video signals which are then supplied to a monitor 316. The scan conversion unit 304 and/or the delineating unit 306 can be implemented by the processor 302.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A computer graphics system (300) arranged to render polygons, comprising:
a frame memory (310) to store values of pixels;
a scan conversion unit (304) for determining which of the pixels are inside a particular polygon (100); and
a delineating unit (306) for delineating the particular polygon, being arranged to eliminate Jags (108-116) on an edge (102) of the particular polygon (100) by mixing values of at least two of the pixels to achieve an appropriate value of a particular pixel to be displayed, characterized in that the scan conversion unit (304) is designed to determine information of the Jags (108-116) to control the delineating unit (306).

2. A computer graphics system (300) as claimed in claim 1, characterized in that the delineating unit (306) is designed to calculate the appropriate value of the particular pixel on the basis of a distance between the particular pixel (242) and a particular Jaggy (204).

3. A computer graphics system (300) as claimed in claim 1, characterized in further comprising a memory device (312) being arranged to store the information of the particular Jaggy (204), provided by the scan conversion unit (304).

4. A computer graphics system (300) as claimed in claim 3, characterized in that the memory device (312) is a Z-buffer.

5. A computer graphics system (300) as claimed in claim 4, characterized in that the information of the particular Jaggy (204) comprises a location of the particular Jaggy (204).

6. A computer graphics system (300) as claimed in claim 4, characterized in that the information of the particular Jaggy (204) comprises an orientation of the edge (202).

7. A computer graphics system (300) as claimed in claim 4, characterized in that the information of the particular Jaggy (204) is stored in one bit-layer of the Z-buffer (312).

8. A computer graphics system (300) as claimed in claim 4, characterized in that the information of the particular Jaggy (204) comprises a relation between the particular Jaggy (204) and a second Jaggy (208).

9. A method of rendering polygons comprising the steps of:
storing values of pixels in a frame memory (310);
scan conversion (304) to determine which of the pixels are inside a particular polygon (100); and
delineating the particular polygon to eliminate Jags (108-116) on an edge (102) of the particular polygon (100) by mixing values of at least two of the pixels to achieve an appropriate value of a particular pixel to be displayed, characterized in that in the step of scan conversion, information of the Jags (108-116) is determine to control the delineating.

10. A method of rendering polygons as claimed in claim 9, characterized in that the information of a particular Jaggy (204) detected in the step of scan conversion is stored in a Z-buffer (312).
